(19) United States
(12) Patent Application Publication
(10) Pub. No.: US 2008/0312993 A1
(43) Pub. Date: Dec. 18, 2008

(54) INFORMATION PROCESSING SYSTEM, INFORMATION PROCESSING METHOD, AND COMPUTER READABLE MEDIUM

(75) Inventor: Toshihide YOSHIMURA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/016,237

(22) Filed: Jan. 18, 2008

(30) Foreign Application Priority Data
Jun. 15, 2007 (JP) 2007-159057

(51) Int. Cl. G06Q 10/00; G06F 17/30

(52) U.S. Cl. 705/7; 705/30; 707/104.1; 707/E17.009

(57) ABSTRACT

An information processing system includes: an action storage unit that stores an item of an action in business and a record of the action in business; a selection unit that selects the item of the action stored in the action storage unit; a voucher item storage unit that stores the item of the action selected by the selection unit as an item concerning a voucher; and an item output unit that outputs an item for voucher collection based on the item concerning the voucher stored in the voucher item storage unit.

### CROSS-REFERENCE TO RELATED APPLICATIONS

This application is based on and claims priority under 35 U.S.C. 119 from Japanese Patent Application No. 2007-159057 filed Jun. 15, 2007.

### BACKGROUND

1. Technical Field

This invention relates to an information processing system, an information processing method, and a computer readable medium.

2. Related Art

In recent years, financial internal control has been demanded. For the financial internal control (hereinafter, also called internal control), “Internal control—integrated framework” presented by COSO (Committee of Sponsoring Organizations of Treadway Commission) in 1992 is a de facto standard; the financial internal control is defined as “one process carried out by a board meeting, a manager, and other staff, intended for offering a rational guarantee to accomplish the three purposes of (1) effectiveness and efficiency of business, (2) reliability of financial statements, and (3) compliance with codes.”

To make an internal control report, it is necessary to search for and check sampled vouchers indicating the validity of control at the performance evaluation time. The vouchers need to be promptly presented as evidences if a presentation request is made according to an external audit.

### SUMMARY

According to an aspect of the present invention, an information processing system includes: an action storage unit that stores an item of an action in business and a record of the action in business; a selection unit that selects the item of the action stored in the action storage unit; a voucher item storage unit that stores the item of the action selected by the selection unit as an item concerning a voucher; and an item output unit that outputs an item for voucher collection based on the item concerning the voucher stored in the voucher item storage unit.

### BRIEF DESCRIPTION OF THE DRAWINGS

Exemplary embodiment of the present invention will be described in detail based on the following figures, wherein:

FIG. 1 is a conceptual module configuration drawing about a configuration example of an embodiment of the invention;

FIG. 2 is a schematic representation to show a system configuration example to implement the embodiment of the invention;

FIG. 3 is a schematic representation to show an outline of a database processing example relevant to populations;

FIG. 4 is a schematic representation to show operation screen examples of association of an integrated population and voucher information with each other;

FIG. 5 is a schematic representation to show an operation screen example of sampling processing;

FIG. 6 is a schematic representation to show an operation screen example of sampling processing;

FIG. 7 is a schematic representation to show a sampling processing example;

FIG. 8 is a schematic representation to show a menu screen example in a multiple function processing machine;

FIG. 9 is a schematic representation to show a performance evaluation screen example in the multiple function processing machine;

FIG. 10 is a schematic representation to show a registration screen example in the multiple function processing machine; and

FIG. 11 is a block diagram to show a hardware configuration example of a computer for implementing the embodiment of the invention.

### DETAILED DESCRIPTION

An embodiment of the invention relates to management of vouchers in internal control.

To begin with, an outline of the embodiment will be discussed.

Dispersed populations are integrated (the term “integrate” contains the concept of “join”), thereby creating an integrated population containing the item of the voucher to be found. For a voucher of a paper medium, the voucher and the integrated population are associated with each other and the item is presented to the person in charge, who then searches for the sampled voucher. For an electronic voucher, the vouchers to be sampled are collected by using association of a link of each stored voucher and the attribute of the integrated population with each other.

Next, the terms “basic four documents,” “risk,” “control,” “population,” etc., of the internal control will be discussed.

The basic four documents refer to basic documents created for each business process to which the financial internal control is applied; specifically they are a business description, a business flowchart, an RCM (risk control matrix), and a duty separation table. Business process handling is performed in accordance with the basic four documents.

The business description is also called narrative. It is documentation of a flow of a business sequence from transaction start to final entry into a general ledger to report. Stipulation papers of personnel stipulation, accountant's business stipulation, etc., are high-ranked documents of the business description and their revision has the effect on the business description. A business manual is a low-ranked document of the business description and is affected by revision of the business description.

The business flowchart is a visual flowchart of a flow of a business sequence from transaction start to final entry into a general ledger to report. The risk and the control are also placed on the flow.

The RCM (risk control matrix) is a list of the control points (assertions) to be accomplished and assumed risks about the internal control activities relevant to the business process and the corresponding internal control activities.

The duty separation table is a table for checking whether or not duplication of processing by the same person in charge as causing a problem on the financial control occurs in the business process flow.

The assertions are preconditions to ensure that the financial information is reliable information; specifically the six items of existence, comprehension, evaluation, right and duty, time period/allocation, and display are generally used. Since partial change occurs from one company to another and from one audit cooperation to another, it is desirable that the assertion can be customized.

The risk refers to a hindrance factor for the assertion assumed on the business process. For example, a risk in a receipt processing job is like “approval although no receipt is added.”

The control refers to the internal control activity for a risk and the control types include prevention, finding, etc. For example, the control for the above-mentioned risk in the receipt processing job is like that “the person who takes charge of accepting receipt processing in the accounts department must always collate the account description with the actual one of the added receipt.”

The population refers to a set of data recording the actions (containing acts) conducted in the business process to which the internal control is applied. Specifically, for example, the population refers to a database recording the transaction number, the transaction details, the transaction date, etc., of a thing generated by the action. As for the population used in the embodiment, a portion necessary and sufficient for indicating that the key control to be tested in performance evaluation effectively functions from within the essential population is referred to as population.

There is virtually one population; in fact, however, the case where plural populations disperse for each management system (accounting system, distribution system, etc.,) often occurs. The embodiment is mainly intended for the case where plural populations disperse.

The voucher refers to a record of the action as evidence in carrying out the business process, such as an invoice or a receipt. The voucher may be a paper medium or may be electronic (electronic document, data set, etc.,).

The trail refers to a date seal, a seal of signature, etc., as evidence recorded on a voucher.

The action refers to doing performed in a management system in the business process; specifically it refers to operation of input, approval, etc., by the operator using the management system or processing of calculation, transmission, etc., performed by the management system. The item of the action refers to the name to mention or classify the general action to record the action. In the example described above, “input,” “approval,” “calculation,” “transmission,” etc., correspond to the item of the action.

Referring now to the accompanying drawings, there is shown a preferred embodiment to embody the invention.

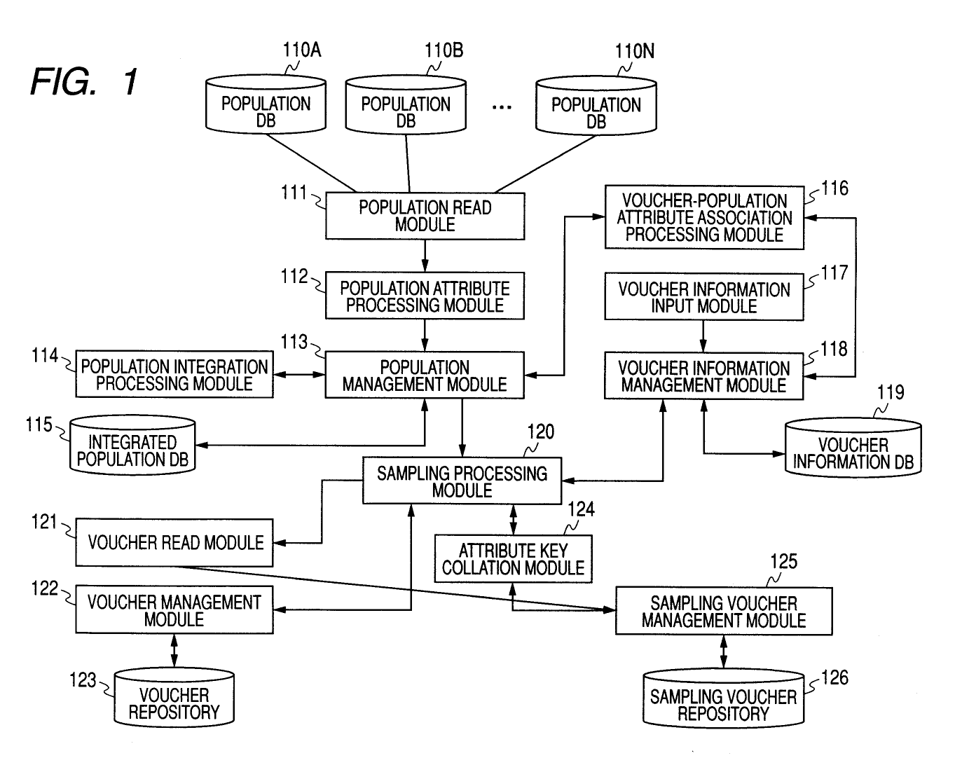

FIG. 1 is a conceptual module configuration drawing about a configuration example of the embodiment of the invention.

A module refers to a generally and logically detachable component of software (computer program), hardware, etc. Therefore, the module in the embodiment means not only a module in a computer program, but also a module in the hardware configuration. Therefore, the embodiment also serves as the description of a computer program, a system, and a method. For the convenience of the description, “store” and its equivalent word are used, however, if the embodiment is a computer program, the words are used to mean storing in storage or controlling so as to store in storage. Modules are almost in a one-to-one correspondence with functions; however, in implementation, one module may be one program or two or more modules may make up one program or two or more programs may make up one module. Two or more modules may be executed by one computer or one module may be executed in two or more computers in a distributed or parallel environment. One module may contain any other module. In the description to follow, the term “connection” contains not only physical connection, but also logical connection (data transfer, command, reference relationship between data pieces, etc.,).

The system or apparatus is not only provided by connecting plural computers, hardware devices, units, etc., by communication means such as a network (containing peer-to-peer communication connection), etc., but also implemented as one computer, hardware device, apparatus, etc.

The embodiment has population DBs 110, a population read module 111, a population attribute processing module 112, a population management module 113, a population integration processing module 114, an integrated population DB 115, a voucher-population attribute association processing module 116, a voucher information input module 117, a voucher information management module 118, a voucher information DB 119, a sampling processing module 120, a voucher read module 121, a voucher management module 122, a voucher repository 123, an attribute key collation module 124, a sampling voucher management module 125, and a sampling voucher repository 126, as shown in FIG. 1.

The population DBs 110 (110A, 110B, . . . , 110N) are connected to the population read module 111 and store the items of actions (containing attributes) and the records of the actions in business in each management system. The population DB 110B stores the items of actions and the records of the actions in business different from the items of actions stored in the population DB 110A. Specifically, each management system has the population DB 110B for storing data of the actions executed in the business process in the management system (for example, a long of an operation record, etc.,). The business process handled by one management system differs from that handled by another management system. However, the management systems may match in the item of action in the business process. The data of the action (containing the item of the action) is supplied to the population read module 111.

The population read module 111, which is connected to the population DBs 110 and the population attribute processing module 112, specifies the population DB 110 to be integrated, reads data from the population DB 110, and passes the data to the population attribute processing module 112. Here, the population DB 110 may be specified in response to operation of the operator or a preset population DB 110 may be specified.

The population attribute processing module 112 is connected to the population read module 111 and the population management module 113 and selects the corresponding action item of the items of data received from the population read module 111, namely, the item as a key for jointing the populations. The item may be selected in response to operation of the operator or the item of the same name may be extracted and selected or an item may be selected in accordance with a predetermined rule. The population attribute processing module 112 passes the selected item and the data in the population DB 110 to the population management module 113.

The population management module 113 is connected to the population attribute processing module 112, the population integration processing module 114, the integrated population DB 115, the voucher-population attribute association processing module 116, and the sampling processing module 120 and passes the attribute item and plural data pieces in the population read module 111 passed from the population attribute processing module 112 to the population integration processing module 114 and instructs the population integration processing module 114 to associate the data pieces in the population read module 111 (generation processing of integrated population). The population management module 113 receives the completed integrated population from the population integration processing module 114 and stores the integrated population in the integrated population DB 115. It also instructs the voucher-population attribute association processing module 116 to associate each voucher and the attribute of the integrated population with each other and instructs the sampling processing module 120 to perform voucher sampling processing for performance evaluation.

The population integration processing module 114 is connected to the population management module 113 and integrates the items of actions and the records of the actions stored in the population DBs 110 based on the item selected by the population attribute processing module 112, thereby generating the item of action and the record of the action in business to be stored in the integrated population DB 115. Specifically, the population integration processing module 114 associates the received data pieces in the population read module 111 according to the specified item in accordance with the instruction from the population management module 113. Accordingly, one integrated population is generated. The population integration processing module 114 passes the generated integrated population to the population management module 113.

The integrated population DB 115 is connected to the population management module 113 and stores the items of actions and the records of the actions in business. This means that the integrated population DB 115 stores the integrated population passed from the population management module 113. It also passes the stored integrated population data in accordance with the instruction from the population management module 113.

The voucher-population attribute association processing module 116 is connected to the population management module 113 and the voucher information management module 118 and selects the item of action stored in the integrated population DB 115 and associates voucher and the item of the integrated population with each other. Specifically, the voucher-population attribute association processing module 116 selects the item of action in the integrated population as the item to be associated with the voucher.

The voucher information input module 117 is connected to the voucher information management module 118 and inputs information concerning a voucher occurring according to an action in the business process. The information may be input in response to operation of the operator or may be input from each management system. The voucher information input module 117 passes the input information concerning the voucher to the voucher information management module 118.

The voucher information management module 118 is connected to the voucher-population attribute association processing module 116, the voucher information input module 117, the voucher information DB 119, and the sampling processing module 120 and manages information concerning vouchers. Specifically, the voucher information management module 118 stores the information concerning vouchers received from the voucher information input module 117 in the voucher information DB 119 and stores the item associated by the voucher-population attribute association processing module 116 in the voucher information DB 119. It also passes the information concerning the voucher to be sampled to the sampling processing module 120 in response to an instruction from the sampling processing module 120.

The voucher information DB 119 is connected to the voucher information management module 118 and stores the information concerning the voucher received from the voucher information management module 118. It stores the item of action selected by the voucher-population attribute association processing module 116 as the item concerning voucher. Further, the voucher information DB 119 stores the item of action selected by the voucher-population attribute association processing module 116 and information concerning the storage location of electronic information of voucher stored in the voucher repository 123 as the item concerning the voucher. The information concerning the storage location of electronic information of the voucher is, for example, a URI (Uniform Resource Identifier) or a URL (Uniform Resource Locator)

The sampling processing module 120 is connected to the population management module 113, the voucher information management module 118, the voucher read module 121, the voucher management module 122, and the attribute key collation module 124 and determines the voucher to be used with performance evaluation of the internal control. Specifically, the sampling processing module 120 uses information from the population management module 113 and the voucher information management module 118 to sample the voucher to be verified in performance evaluation in response to operation of the operator. If the voucher is a paper medium, the sampling processing module 120 passes the item indicating the attribute of the voucher and the description thereof to the voucher read module 121. If the voucher is electronic information, the sampling processing module 120 instructs the voucher management module 122 to take out the voucher. It instructs the attribute key collation module 124 to take out the sampled voucher.

The voucher read module 121 is connected to the sampling processing module 120 and the sampling voucher management module 125 and receives the item concerning the voucher stored in the voucher information DB 119 through the voucher information management module 118 and the sampling processing module 120 and outputs an item for voucher collection based on that item. The voucher read module 121 may receive the description corresponding to the item stored in the integrated population DB 115 through the population management module 113 and the sampling processing module 120 and may output the description together with the item name. Specifically, to read the image of the voucher of a paper medium, the item for searching for the voucher and the description thereof (for example, voucher name, transaction number, etc.,) are displayed on a screen of a scanner. The image of the voucher determined by the sampling processing module 120 is given the attribute of the output item described above and is accepted. Specifically, the voucher is read through the scanner by the operator, the item output to the screen of the scanner is given as the attribute, and the sample voucher image is passed to the sampling voucher management module 125.

The voucher management module 122 is connected to the sampling processing module 120 and the voucher repository 123 and extracts the voucher determined by the sampling processing module 120 from the voucher repository 123 based on the information concerning the storage location stored by the voucher information DB 119. Specifically, if the voucher is electronic information, the electronic information of the voucher is taken out from the voucher repository 123 storing the voucher.

The voucher repository 123 is connected to the voucher management module 122 and stores the electronic information of a voucher occurring according to an action in the business.

The attribute key collation module 124 is connected to the sampling processing module 120 and the sampling voucher management module 125. The attribute key collation module 124 acquires the attribute key of the voucher to be sampled stored in the voucher information DB 119 from the voucher information management module 118 through the sampling processing module 120 in response to an instruction of the sampling processing module 120. The attribute key collation module 124 also acquires the attribute key of the voucher stored in the voucher repository 123 from the voucher management module 122. Then, the attribute key collation module 124 collates the value of the attribute key of the voucher acquired from the voucher information management module 118 with the value of the attribute key of the voucher acquired from the voucher management module 122 and if a predetermined condition is satisfied (for example, the values equal, etc.,), the attribute key collation module 124 sends a request for copying the voucher stored in the voucher repository 123 to the sampling processing module 120.

In response to the request received from the attribute key collation module 124, the sampling processing module 120 acquires a copy of the voucher stored in the voucher repository 123 from the voucher management module 122 and transmits the copy of the voucher through the attribute key collation module 124 to the sampling voucher management module 125.

The sampling voucher management module 125 is connected to the voucher read module 121, the attribute key collation module 124, and the sampling voucher repository 126. The sampling voucher management module 125 stores the copy of the voucher sent through the attribute key collation module 124 from the sampling processing module 120 in the sampling voucher repository 126. The sampling voucher repository 126 is connected to the sampling voucher management module 125 and stores the image of the voucher accepted by the voucher read module 121 as a sample voucher. It also stores the electronic information of the voucher extracted by the sampling processing module 120 as a sample voucher.

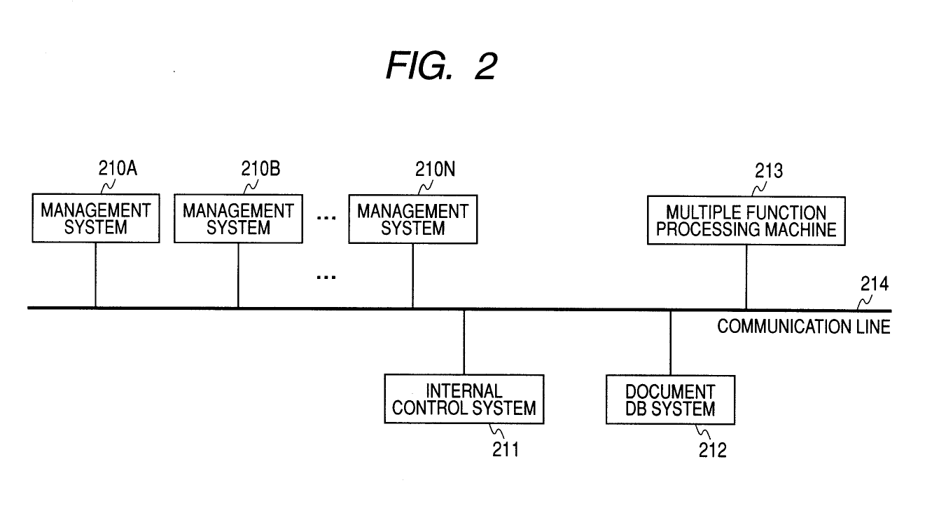

A system configuration example to implement the embodiment of the invention will be discussed with FIG. 2. A system shown in FIG. 2 has a management system 210A, a management system 210B, a management system 210N, an internal control system 211, a document DB system 212, and a multiple function processing machine 213, which are connected to each other through a communication line 214.

Each management system 210 has a population database 110 and handles the business process.

The multiple function processing machine 213 has the voucher read module 121 and is a multiple function processing machine for inputting an image of a voucher of a paper medium (image processing apparatus having the function of any of a scanner, a printer, a copier, a facsimile, etc.,). It may be a scanner or a facsimile as well as a multiple function processing machine.

The document DB system 212 is a database system for storing electronic documents (containing those of electronic data, image data, etc.,) of vouchers, etc., in the voucher information DB 119, the voucher repository 123, and the sampling voucher repository 126.

The internal control system 211 has the population read module 111 to the voucher information management module 118, the sampling processing module 120, the voucher management module 122, the attribute key collation module 124, and the sampling voucher management module 125; it is a system for managing the internal control.

The relationship between the systems, etc., shown in FIG. 2 and the modules, etc., shown in FIG. 1 is shown by way of example and each module may be constructed not only in the above-described system, but also in any other system.

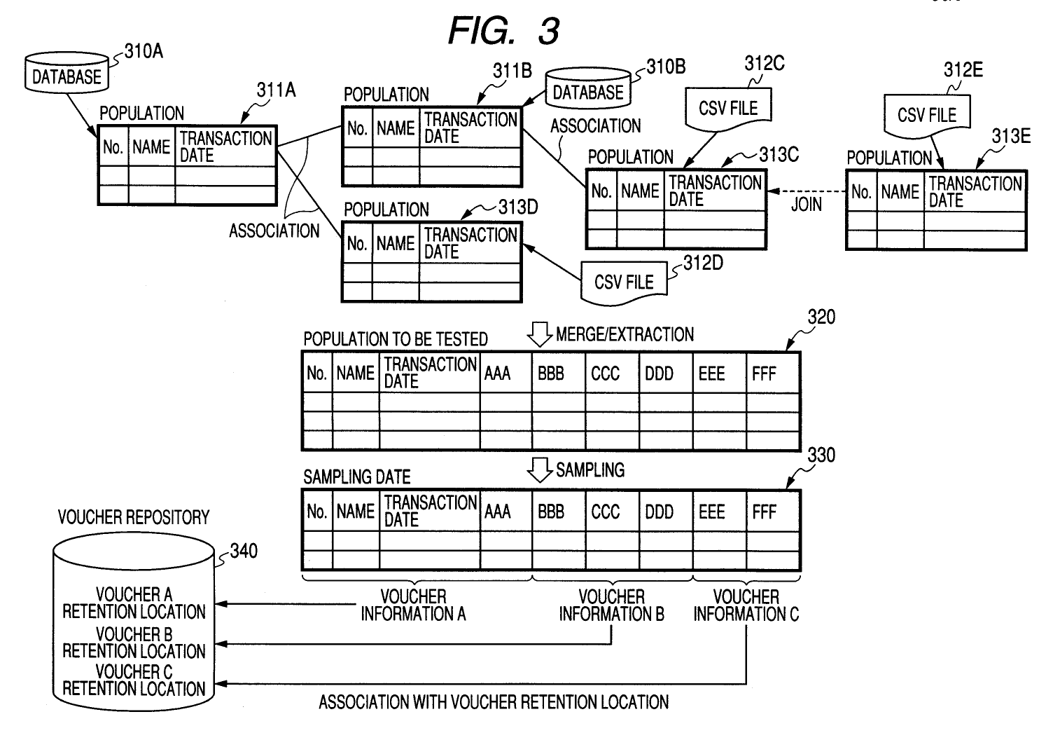

An outline of a database processing example relevant to populations will be discussed with FIG. 3.

A database 310A, a database 310B, a CSV (Comma Separated Value) file 312C, a CSV file 312D, and a CSV file 312E correspond to the population DB 110 and store a population 311A, a population 311B, a population 313C, a population 313D, and a population 313E respectively. That is, the population DB 110 may be in the database format or may be in the format of the CSV file, etc. Each of the populations 311 and 313 is a table having the attributes of the item names of No., name, and transaction date as the record of an action. The items of the populations 311 and 313 are illustrative; any other item may be included and the populations 311 and 313 may have different items.

The population 311A is associated with the populations 311B and 313D and the population 311B is associated with the population 313C and further the populations 313C and 313E will be joined. The populations are associated and are joined as the items in the populations 311 and 313 correspond, etc.

The population integration processing module 114 receives the populations 311 and 313 and integrates the populations in accordance with the corresponding items to generate a tested population 320. This means that the population integration processing module 114 generates an integrated population. The tested population 320 is a collection of the items of the populations and therefore the number of items increases.

Next, the sampling processing module 120 extracts a sample voucher used with performance evaluation from the tested population 320 and generates sampling data 330.

The sampling voucher management module 125 takes out the electronic information of the voucher, the image of the voucher stored in a voucher repository 340 corresponding to the items in the sampling data 330. The voucher repository 340 corresponds to the voucher repository 123 or the sampling voucher repository 126.

The generation processing of the integrated population will be discussed in more detail. The processing is performed using the population DBs 110 to the integrated population DB 115.
(1-1) The population read module 111 specifies the population to be integrated. The specified population is a population recording the actions for which performance evaluation is to be conducted. The data format of the specified population may be any, such as a database or a CSV file.
(1-2) The population read module 111 acquires data from the population. At this time, item selection, item name change, etc., in the population can be performed in response to operation of the operator.
(1-3) If the number of the populations is only one, the population is adopted as the population to be sampled.
(1-4) If plural populations are dispersed, steps (1-1) and (1-2) are repeated for acquiring the data in the plurality of populations individually.
(1-5) The population attribute processing module 112 specifies the item used as the key for joining the acquired populations. The population integration processing module 114 associates the populations with each other.
(1-6) The population integration processing module 114 collects the attributes associated in (1-5) for each key attribute and creates a new population to be sampled. The population management module 113 stores the population in the integrated population DB 115.

The association processing of the integrated population and voucher information with each other will be discussed in more detail. This processing is performed by the voucher-population attribute association processing module 116 to the voucher information DB 119.
(2-1) The voucher information input module 117 creates an entry of the voucher information to be registered.
(2-2) The voucher-population attribute association processing module 116 selects the item of the integrated population to be associated with the voucher.
(2-3) If the voucher is a paper medium, the voucher information management module 118 registers a set of items of the integrated population relevant to the voucher in the voucher information DB 119 as voucher information. For example, the voucher information management module 118 registers the fact that voucher X is made up of items A, B, and C of the integrated population, that voucher Y is made up of items A, C, and F of the integrated population, etc., in the voucher information DB 119.
(2-4) If the voucher is electronic information and is stored in the voucher repository 123, the electronic voucher item and the integrated population item are associated with each other. One item of the population and two or more vouchers may be associated with each other; two or more items of the population may be associated with one item of the voucher.

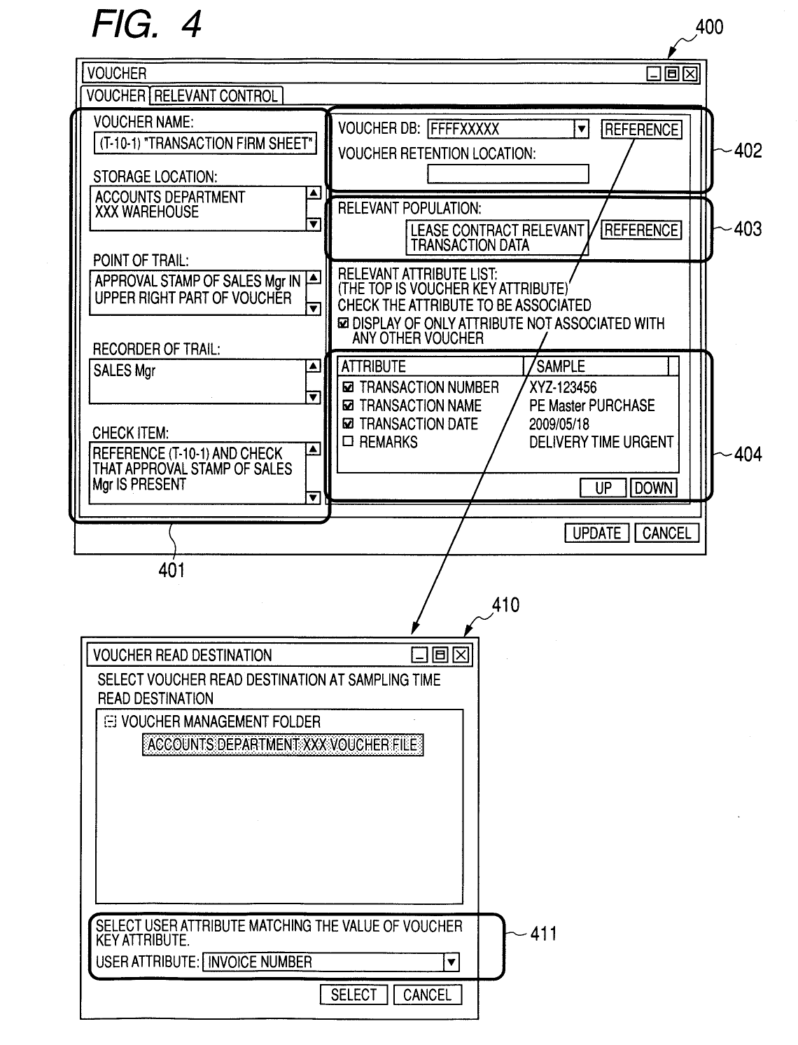

Operation screens in the association processing of the integrated population and the voucher information with each other will be discussed with FIG. 4.

A voucher screen 400 has a voucher general information area 401, a voucher retention location area 402, a relevant population area 403, and an attribute association area with population 404.

Voucher name, storage location, point of trail, recorder of trail, check item, and the like are presented in the voucher general information area 401.

A voucher DB can be specified in the voucher retention location area 402. If the operator presses a reference button, a voucher read destination screen 410 is presented. The databases are displayed hierarchically on the voucher read destination screen 410 so that the voucher read destination at the sampling time can be specified. The voucher read destination screen 410 has an association area 411 with the repository attribute of the voucher retention location. The voucher item and the population item matching it can be specified in the association area 411 with the repository attribute of the voucher retention location.

A relevant population can be specified in the relevant population area 403.

The item name (attribute name) in the integrated population and a sample of the value of the item are presented in a pair in the attribute association area with population 404, enabling the operator to associate the attribute with the population by checking a check box.

The sampling processing (when the voucher is a paper medium and the image of the voucher is read) will be discussed in more detail. This processing is performed by the sampling processing module 120 and the voucher read module 121.
(3-1) The sampling processing module 120 specifies a sampling condition and a sampling method from the integrated population and performs sampling.
(3-2) The sampling processing module 120 acquires the voucher type required for sampling and the attribute value (specific data of the transaction number concerning the voucher, etc.,) from each sampling result record and the voucher information associated with the population by the voucher information management module 118.
(3-3) The voucher read module 121 presents the result information in (3-2) on a screen of the multiple function processing machine 213. This means that the voucher read module 121 informs the person in charge, of the voucher to be input by the scanner function of the multiple function processing machine 213. To inform the person in charge, mail, a Web page, etc., may be used in addition to presenting the information to the screen of the multiple function processing machine 213.
(3-4) The person in charge searches for the voucher of the actual article based on the presented information and inputs the voucher by the scanner function of the multiple function processing machine 213.

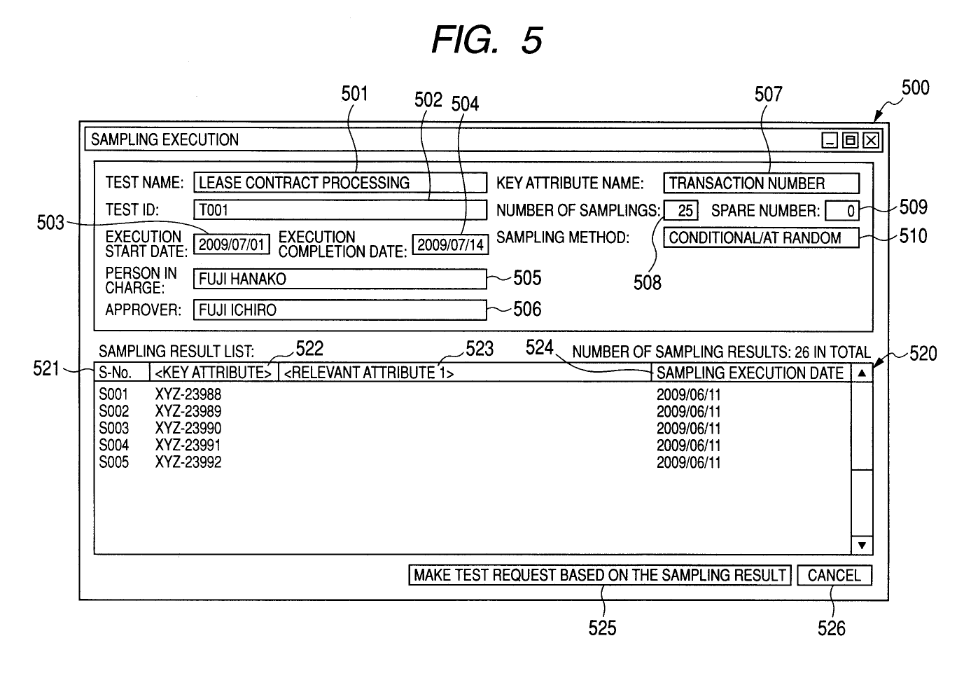

Operation screen examples in the sampling processing (when the voucher is a paper medium) will be discussed with FIGS. 5, 6, and 8 to 10.

An operation screen example in the sampling processing presented by the sampling processing module 120 will be discussed with FIG. 5.

A sampling execution screen 500 has a test name field 501, a test ID field 502, an execution start date field 503, an execution completion date field 504, a person in charge field 505, an approver field 506, a key attribute name field 507, a number-of-samplings field 508, a spare number field 509, a sampling method field 510, a sampling result list 520, a request button 525 for making a test request based on the sampling result, and a cancel button 526 for canceling. The sampling result list 520 has an S-No. field 521, a key attribute field 522, a relevant attribute 1 field 523, and a sampling execution date field 524.

The operator enters necessary items for performance evaluation in the test name field 501 to the approver field 506 and specifies a sample method and the number of samples in the key attribute name field 507 to the sampling method field 510. The sampling result is presented to the sampling result list 520. If the operator presses the request button 525 for making a test request based on the sampling result, a performance evaluation request is sent to the person in charge of conducting performance evaluation.

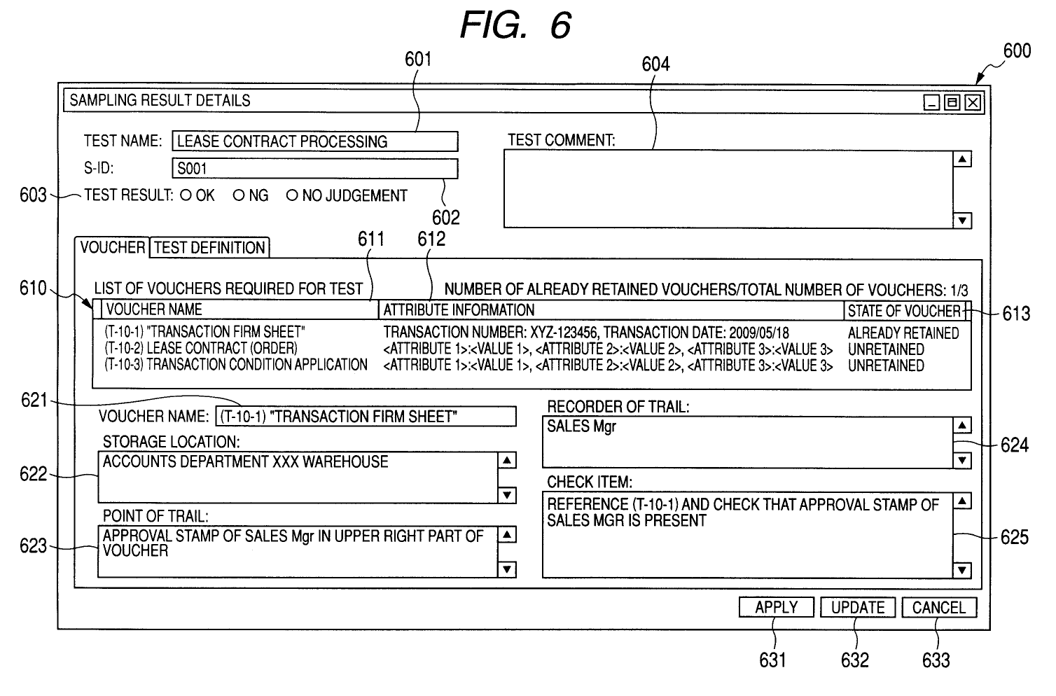

An operation screen example in performance evaluation (sampling test) presented by the sampling processing module 120 will be discussed with FIG. 6. This screen is mainly operated by the person in charge of conducting performance evaluation.

A sampling test result detail screen 600 has a test name field 601, an S-ID field 602, a test result field 603, a test comment field 604, a voucher list required for test 610, a voucher name field 621, a storage location field 622, a trail point field 623, a trail recorder field 624, a check item field 625, an apply button 631, an update button 632, and a cancel button 633. The voucher list required for test 610 has a voucher name field 611, an attribute information field 612, and a voucher state field 613.

The person in charge of conducting performance evaluation checks the sampled voucher, selects the test result in the test result field 603, and makes an entry in the test comment field 604. The item associated with the item of the integrated population is presented to the attribute information field 612.

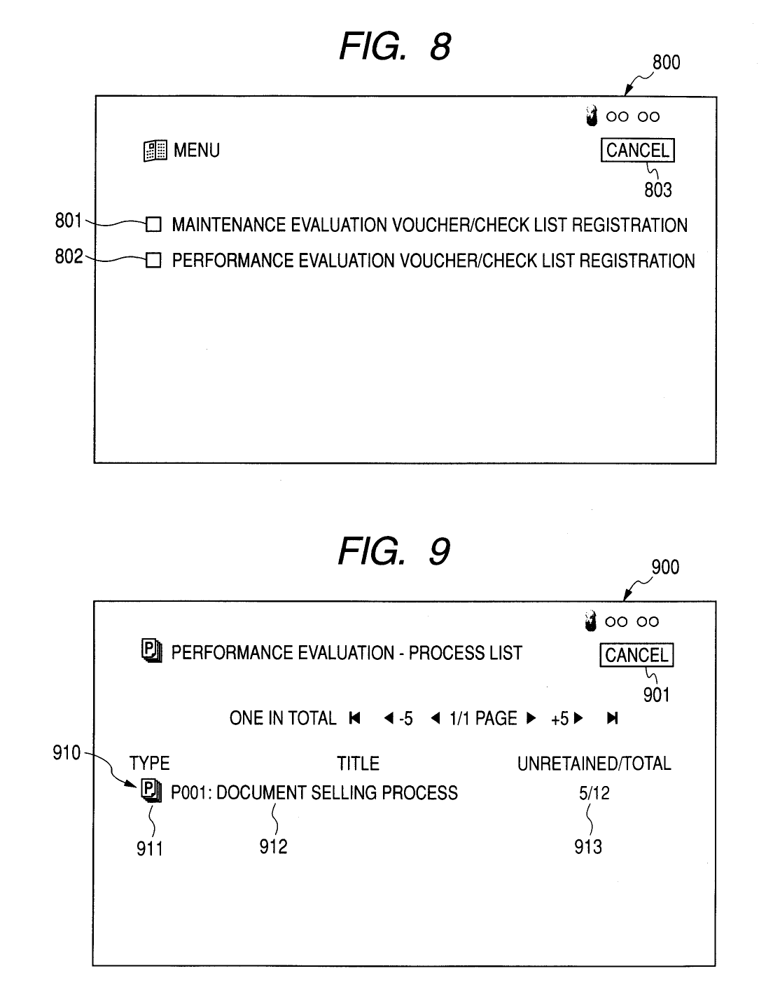

FIGS. 8 to 10 show examples of operation screens presented to the multiple function processing machine 213.

An example of a menu screen 800 will be discussed with FIG. 8.

The menu screen 800 has a maintenance evaluation voucher/check list registration field 801, a performance evaluation voucher/check list registration field 802, and a cancel button 803. If the operator presses the performance evaluation voucher/check list registration field 802, a performance evaluation screen 900 is presented. The operator previously logs in to the internal control system 211. The operator name is presented in the upper right portion of each screen.

An example of the performance evaluation screen 900 will be discussed with FIG. 9.

The performance evaluation screen 900 has a cancel button 901 and a process list 910. The process list 910 has a type field 911, a title field 912, and an unsaved/complement field 913. The document name of read of the voucher requested by the operator is presented.

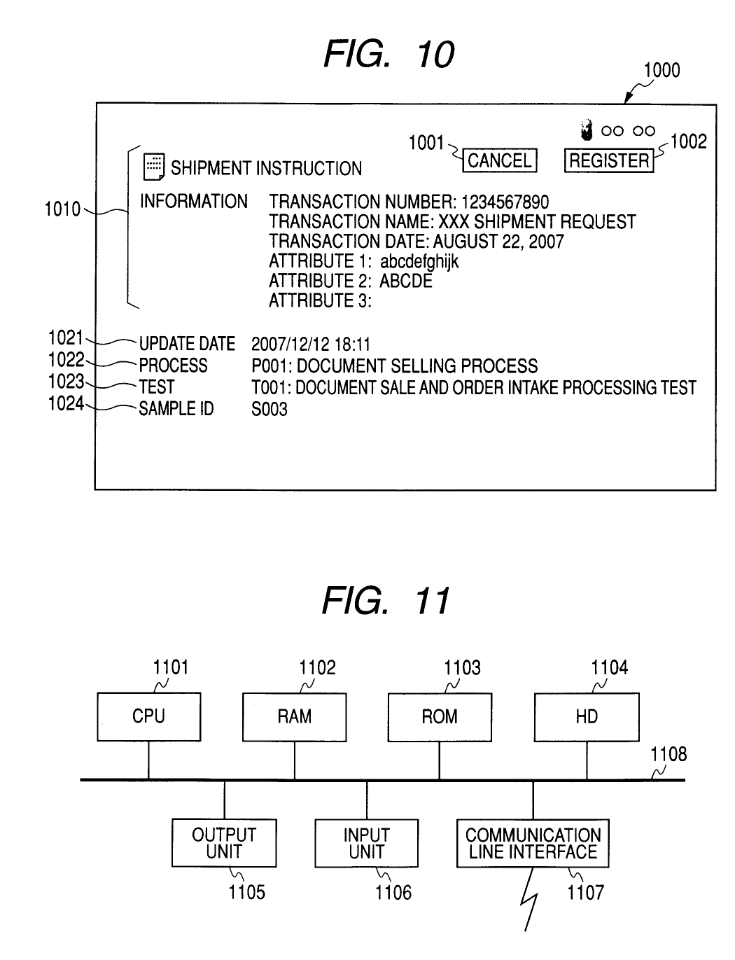

An example of a registration screen 1000 will be discussed with FIG. 10.

The registration screen 1000 has a cancel button 1001, a registration button 1002, a registration voucher attribute display area 1010, an update date field 1021, a process field 1022, a test field 1023, and a sample ID field 1024. If the voucher to be read is selected through the performance evaluation screen 900, the detailed items of the voucher to be read and the descriptions of the items are presented. That is, they are presented to the registration voucher attribute display area 1010 as item: transaction number, the description of the item: 1234567890, item: transaction name, the description of the item: XX shipment request. Other items are also presented to the update date field 1021, etc.

That is, based on the selected item in the integrated population associated as the item of the voucher to be read, the item and the description of the item are presented to the registration voucher attribute display area 1010. After the image of the voucher is read, the presented item, etc., is stored in the sampling voucher repository 126 as the attribute of the image of the voucher.

The sampling processing (when the voucher is electronic information and automatic sampling is performed by executing item collision) will be discussed in more detail. This processing is performed by the sampling processing module 120, the voucher management module 122, and the voucher repository 123.
(4-1) The sampling processing module 120 specifies a sampling condition and a sampling method from the integrated population and performs sampling.
(4-2) The sampling processing module 120 acquires the voucher type required for sampling and the attribute value (specific data of the transaction number concerning the voucher, etc.,) from each sampling result record and the voucher information associated with the population by the voucher information management module 118.
(4-3) If the voucher is electronic information and is associated in (2-4), the sampling processing module 120 copies the corresponding original voucher in the voucher repository 123 into the sampling voucher repository 126 as the voucher to be sampled. In this case, information concerning the storage location of the electronic information of the voucher (for example, URI) is used to access. The information concerning the storage location of the electronic information of the voucher is stored in the voucher information DB 119 as the item concerning the voucher.

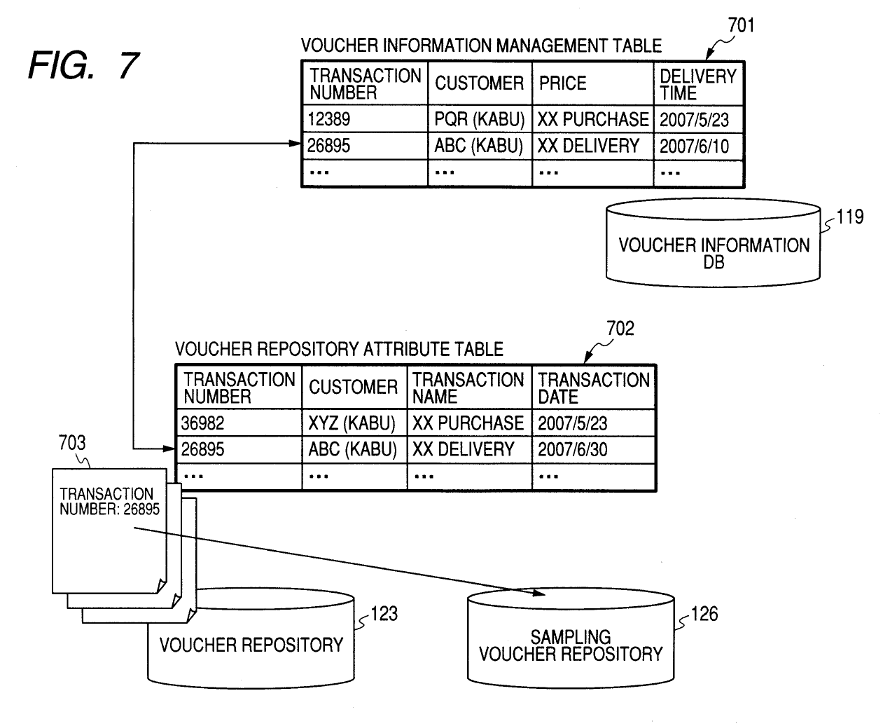

An outline of an example of the sampling processing (when the voucher is electronic information) will be discussed with FIG. 7.

A voucher information management table 701 is stored in the voucher information DB 119. A voucher repository attribute table 702 is stored in the voucher repository 123.

In this example, the management number of the item of the voucher information management table 701 and the transaction number of the item of the voucher repository attribute table 702 are made to correspond by the voucher-population attribute association processing module 116.

At the sampling processing time, the sampling processing module 120 extracts the voucher corresponding to the entry in the voucher information management table 701 from the voucher repository attribute table 702. That is, in the example, the description of the management number of the item in the voucher information management table 701 is collated with the description of the transaction number of the corresponding item in the voucher repository attribute table 702. A voucher 703 with the management number and the transaction number matching (in the example, “26895”) is copied into the sampling voucher repository 126.

The hardware configuration of a computer for executing a program as the embodiment is a general computer as shown in FIG. 11; specifically it is a personal computer, a computer that can become a server, or the like. It is made up of a CPU 1101 for executing the programs of the population read module 111, the population integration processing module 114, the sampling processing module 120, etc., RAM 1102 for storing the programs and data, ROM 1103 storing a program for starting the computer and the like, an HD 1104 of auxiliary storage (for example, a hard disk can be used), an input unit 1106 for entering data such as a keyboard or a mouse, an output unit 1105 of a CRT, a liquid crystal display, etc., a communication line interface 1107 for connecting to a communication network (for example, a network interface card can be used), and a bus 1108 for connecting the components for transferring data. Two or more computers may be connected by a network.

For the part based on the computer program in the embodiment described above, the computer program of software is read into the system of the hardware configuration and the software and hardware resources work in cooperation, thereby implementing the embodiment described above.

The hardware configuration shown in FIG. 11 shows one configuration example and the embodiment is not limited to the configuration in FIG. 11 and any configuration may be adopted if it makes it possible to execute the modules described in the embodiment. For example, some modules may be implemented as dedicated hardware (for example, an ASIC, etc.,) and some modules may be included in an external system and may be connected via a communication line and further plural systems shown in FIG. 11 may be connected via a communication line so as to operate in cooperation with each other. The system may be built in a home information appliance, a copier, a fax, a scanner, a printer, a multiple function processing machine, etc., in addition to a personal computer.

In the embodiment described above, the table structure is shown as the mode of the data of a population, etc., but any other data structure may be adopted. For example, a list structure, etc., may be adopted. Any other item than those illustrated may be adopted and other items may be added.

The described program may be provided as it is stored on a record medium or the program may be provided by communication means. In this case, for example, the described program may be grasped as the invention of a computer-readable record medium recording a program.”
The expression “computer-readable record medium recording a program” is used to mean a record medium read by a computer recording a program, used to install and execute a program, to distribute a program, etc.

The record media include “DVD-R, DVD-RW, DVD-RAM, etc.,” of digital versatile disk (DVD) and standard laid down in DVD Forum, “DVD+R, DVD+RW, etc.,” of standard laid down in DVD+RW, read-only memory (CD-ROM), CD recordable (CD-R), CD rewritable (CD-RW), etc., of compact disk (CD), magneto-optical disk, flexible disk (FD), magnetic tape, hard disk, read-only memory (ROM), electrically erasable and programmable read-only memory (EEPROM), flash memory, random access memory (RAM), etc., for example.

The described program or a part thereof may be recorded in any of the described record media for retention, distribution, etc. The described program or a part thereof may be transmitted by communications using a transmission medium such as a wired network used with a local area network, a metropolitan area network (MAN), a wide area network (WAN), the Internet, an intranet, an extranet, etc., or a wireless communication network or a combination thereof, etc., for example, and may be carried over a carrier wave.

Further, the described program may be a part of another program or may be recorded in a record medium together with a different program. It may be recorded as it is divided into plural record media. It may be recorded in any mode if it can be restored, such as compression or encryption.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing system comprising:
an action storage unit that stores an item of an action in business and a record of the action in business;
a selection unit that selects the item of the action stored in the action storage unit;
a voucher item storage unit that stores the item of the action selected by the selection unit as an item concerning a voucher; and
an item output unit that outputs an item for voucher collection based on the item concerning the voucher stored in the voucher item storage unit.

2. The information processing system as claimed in claim 1, further comprising:
a voucher determination unit that determines a voucher used with evaluation of internal control;
a voucher image acceptance unit that gives an attribute of an item output by the item output unit to an image of the voucher determined by the voucher determination unit, and that accepts the image of the voucher to which the attribute is given; and
a sample voucher storage unit that stores the image of the voucher accepted by the voucher image acceptance unit as a sample voucher.

3. An information processing system comprising:
an action storage unit that stores an item of an action in business and a record of the action in business;
a voucher storage unit that stores electronic information of a voucher occurring according to the action in business;
a selection unit that selects the item of the action stored in the action storage unit; and
a voucher item storage unit that stores the item of the action selected by the selection unit and information concerning the storage location of the electronic information of the voucher stored in the voucher storage unit as items concerning the voucher.

4. The information processing system as claimed in claim 3, further comprising:
a voucher determination unit that determines a voucher used with evaluation of internal control;
a voucher extraction unit that extracts the voucher determined by the voucher determination unit from the voucher storage unit based on the information concerning the storage location stored in the voucher item storage unit; and
a sample voucher storage unit that stores the electronic information of the voucher extracted by the voucher extraction unit as a sample voucher.

5. The information processing system as claimed in claim 1, further comprising:
the action storage unit including:
a first action storage unit that stores an item of a first action in first business and a record of the first action in the first business; and
a second action storage unit that stores an item of a second action in second business and a record of the second action in the second business, the second business being different from the first business;
an item selection unit that selects the item of the second action stored in the second action storage unit corresponding to the item of the first action stored in the first action storage unit; and
an action record generation unit that integrates the item of the first action and the record of the first action stored in the first action storage unit and the item of the second action and the record of the second action stored in the second action storage unit based on the item selected by the item selection unit so as to generate the item of the action and the record of the action in business stored in the action storage unit.

6. The information processing system as claimed in claim 3, further comprising:
a first action storage unit that stores an item of a first action in first business and a record of the first action in the first business;
a second action storage unit that stores an item of a second action in second business and a record of the second action in the second business, the second business being different from the first business;
an item selection unit that selects the item of the second action stored in the second action storage unit corresponding to the item of the first action stored in the first action storage unit; and
an action record generation unit that integrates the item of the first action and the record of the first action stored in the first action storage unit and the item of the second action and the record of the second action stored in the second action storage unit based on the item selected by the item selection unit so as to generate the item of the action and the record of the action in business stored in the action storage unit.

7. An information processing method comprising:
storing an item of an action in business and a record of the action in business;
selecting the stored item of the action;
storing the selected item of the action as an item concerning a voucher; and
outputting an item for voucher collection based on the item concerning the stored voucher.

8. An information processing method comprising:
storing an item of an action in business and a record of the action in business;
storing electronic information of a voucher occurring according to the action in business;
selecting the stored item of the action; and
storing the selected item of the action and information concerning the storage location of the electronic information of the stored voucher as items concerning the voucher.

9. A computer readable medium storing a program causing a computer to execute a process for performing performance evaluation in internal control, the process comprising:
storing an item of an action in business and a record of the action in business;
selecting the stored item of the action;
storing the selected item of the action as an item concerning a voucher; and
outputting an item for voucher collection based on the item concerning the stored voucher.

10. A computer readable medium storing a program causing a computer to execute a process for performing performance evaluation in internal control, the process comprising:
storing an item of an action in business and a record of the action in business;
storing electronic information of a voucher occurring according to the action in business;
selecting the stored item of the action; and
storing the selected item of the action and information concerning the storage location of the electronic information of the stored voucher as items concerning the voucher.
